(19) United States
(12) Patent Application Publication
(10) Pub. No.: US 2026/0043299 A1
(43) Pub. Date: Feb. 12, 2026

(54) Ladder Lockout Assembly

(71) Applicant: Formetco, LLC, Duluth, GA (US)

(72) Inventors: Robert Lee Franklin, Jr., Snellville, GA (US); Brian David Jeffries, Duluth, GA (US); Jonathon Christopher Adams, Hoschton, GA (US)

(73) Assignee: Formetco, LLC, Duluth, GA (US)

(21) Appl. No.: 18/800,060

(22) Filed: Aug. 10, 2024

(51) Int. Cl. E06C 7/00; E06C 9/02

(52) U.S. Cl. CPC E06C 7/006; E06C 9/02

(57) ABSTRACT

A device for limiting access to a permanent ladder mounted on a structure. A lockout plate includes a central panel section, a first inwardly depending longitudinal panel section and an opposing second inwardly depending longitudinal panel. A first hinge bracket is coupled to the lockout plate and a pivotably mounted second hinge bracket coupled to the ladder to define a hinge assembly whereby the lockout plate is rotatable around the hinge pivot pin vertical axis. The hinge assembly includes a detent assembly configured to selectively resist rotation when the lockout plate is in an open position or closed position. A removable retaining pin and retaining pin aperture are provided to selectively retain the lockout plate in the open position, and a staple shaft element provided that is coupled to the ladder and configured to be received through a staple shaft aperture through the lockout plate.

### BACKGROUND OF THE INVENTION

Publicly displayed billboards and signage, manufacturing and refinery operations, agricultural, commercial, and other industrial installations often include elevated or above-ground areas that require infrequent access by authorized personnel for maintenance, repair, modification, inspection and similar activities.

Access to such areas is commonly accomplished by use of a permanently mounted ladder that is mechanically secured to or upon an adjacent structure for stability to permit accessing above (or below) ground areas that are not easily accessible by portable ladder systems.

A major consideration of owners and operators of such facilities is preventing access to these areas by unauthorized individuals who may attempt to vandalize or “tag” publicly displayed surfaces such as billboards, or to damage, destroy or steal items located there. Preventing unauthorized access to such ladder-accessible areas not only reduces risk of property damage or loss, but also minimizes potential premises liability for personal injury to unauthorized users.

### PRIOR ART

A prior art attempt to address the above concerns is found in U.S. Pat. No. 3,968,857, to Bryan entitled, “Device for Preventing Unauthorized Access to Permanent Ladders” (the '857 Patent”). The '857 patent teaches a shield that includes a front plate having two longitudinal side edges, a pair of side flanges, each of which extends rearwardly and outwardly from one of the side edges. A “piano hinge” rotatably connects to one of the side flanges and the front plate. The front plate and one of the opposing side flanges are fixed to each other and are collectively rotatable between an open position and a closed position wherein the front plate, side flanges, and supporting structure substantially enclose a portion of the ladder.

While the device of the '857 patent addresses certain unauthorized ladder access concerns, it can be unstable in an open position due to wind which can inadvertently close or swing the access panel on a user, making it difficult and unsafe to ascend or descend on the ladder. Yet further, the device of the '857 patent has limited panel stability in the closed position and is prone to rattling or shaking due to wind or environmental factors. Finally, one of the two opposing side flanges remains fixed to the ladder rail in the system when in the open position. This not only creates an impediment to a user who is ascending or descending the ladder while laden with a tool belt or bucket, paint, parts, etc., but also poses a substantial safety or fall risk if such items are inadvertently caught on the fixed flange.

What is needed is a ladder lockout assembly that is stable, easily installed, adjusted or removed, and that includes a lockout panel that is stable in both an open and a closed position and is not prone to unintended opening, closing, rotation or vibration due to wind.

### SUMMARY OF THE INVENTION

A ladder lockout assembly is disclosed to minimize unauthorized access to a permanent ladder mounted to a structure.

In a first aspect of the invention, a ladder lockout assembly for limiting access to a ladder is provided. The ladder lockout assembly comprises a lockout plate comprising a central panel section, a first inwardly depending longitudinal panel section and a second inwardly depending longitudinal panel section opposing the first longitudinal panel section.

At least one hinge assembly is provided comprising a first hinge bracket coupled to the lockout plate and a second hinge bracket coupled to the ladder whereby the lockout plate is horizontally rotatable between a first open position and a second closed position. Mounting means, which may comprise adjustable clamping means, is provided to affix the ladder lockout assembly to the respective side rails of the ladder.

The hinge assembly may comprise detent means configured to resist or arrest a lockout plate rotation when the lockout plate is in the first open position or the second closed position.

The ladder lockout assembly may further comprise a removable retaining pin and a retaining pin aperture configured to receive the retaining pin to selectively limit a rotation of the first hinge bracket or the second hinge bracket when the retaining pin is received within the retaining pin aperture.

In a second aspect of the invention, the ladder lockout assembly may further comprise an outwardly projecting staple shaft element coupled to the ladder by clamping means which preferably comprises adjustable clamping means and comprising a lock hasp aperture, the staple shaft element is configured to be received through a staple shaft aperture defined through the lockout plate.

In a third aspect of the invention, the ladder lockout assembly may comprise a mechanical stop element coupled to the ladder by the adjustable clamping means and configured to limit the rotation of the lockout plate at the second closed position.

In a fourth aspect of the invention, the stop element of ladder lockout assembly further comprises a magnet element configured to urge the lockout plate in the second closed position.

In a fifth aspect of the invention, at least one of the central panel section, the first longitudinal panel section or the second panel section comprises a planar surface.

In a sixth aspect of the invention, at least one of the central panel section, the first longitudinal panel section or the second panel section comprises a radial cross-section.

In a seventh, aspect of the invention the detent means comprises an elastic element.

In an eighth aspect of the invention, the detent means comprises a spring element. It is noted that while the illustrated embodiment of the ladder lockout assembly herein shows a spring in a tensioning configuration to effect a detent on the lockout plate in the first open and second closed position, the spring element may also be configured to provide a compression to effect the detent on the lockout plate while in the first open and second closed position.

In a ninth aspect of the invention, the spring element comprises a metal helical spring.

These and various additional aspects, embodiments and advantages of the present invention will become apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF DRAWINGS

FIG. 1 illustrates the ladder lockout assembly of the invention in a second closed position and adjustably mounted or clamped to a permanent ladder affixed to a structure.

FIG. 2 shows the ladder lockout assembly of the invention in a first open position and adjustably mounted or clamped to a permanent ladder affixed to a structure.

FIG. 3 depicts a top-down cross-section of the ladder lockout assembly of the invention in a second closed position and illustrating a stop element and an outwardly projecting staple shaft element mounted on a ladder side rail opposing the hinge assembly and detent means.

FIG. 4 is a top-down cross-section of the ladder lockout assembly of the invention in a first open position and illustrating the stop element and outwardly projecting staple shaft element mounted on a ladder side rail opposing the hinge assembly and detent means.

FIG. 5 illustrates the first hinge bracket and second hinge bracket of the hinge assembly adjustably mounted or clamped to a ladder side rail and comprising a retaining pin received within a retaining pin aperture and showing detent means mechanically coupled to an upwardly depending tab on each of the first and second hinge elements in a first open position.

FIG. 6 shows the first hinge bracket and second hinge bracket of the hinge assembly adjustably mounted or clamped to a ladder side rail and comprising a retaining pin received within the retaining pin aperture and showing detent means mechanically coupled to an upwardly depending tab on each of the first and second hinge brackets in a second closed position.

The invention and its various embodiments can now be better understood by turning to the following description of the preferred embodiments which are presented as illustrated examples of the invention in any subsequent claims in any application claiming priority to this application. It is expressly understood that the invention as defined by such claims may be broader than the illustrated embodiments described below.

### DETAILED DESCRIPTION OF THE INVENTION

Applicant discloses a ladder lockout assembly for limiting or preventing unauthorized access to a permanently mounted ladder.

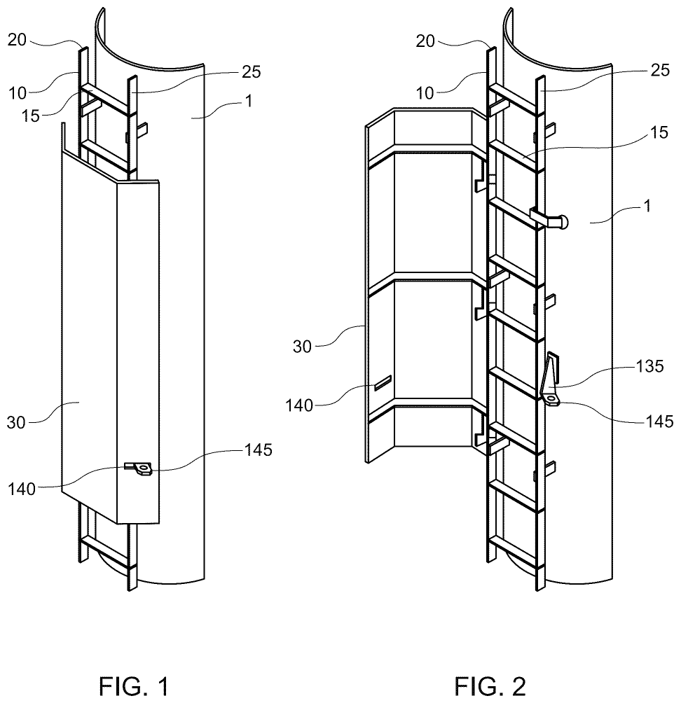

Turning now to the figures, FIG. 1 and FIG. 2 each depict a structure 1 having a ladder 10 permanently mounted thereto. Ladder 10 comprises a plurality of horizontal rungs 15 disposed between a first side rail 20 and an opposing second side rail 25 at spaced-apart vertical distances.

Lockout assembly 30 of the invention mounted on ladder 10 is shown in FIG. 1 and FIG. 2 in the first open and second closed position respectively.

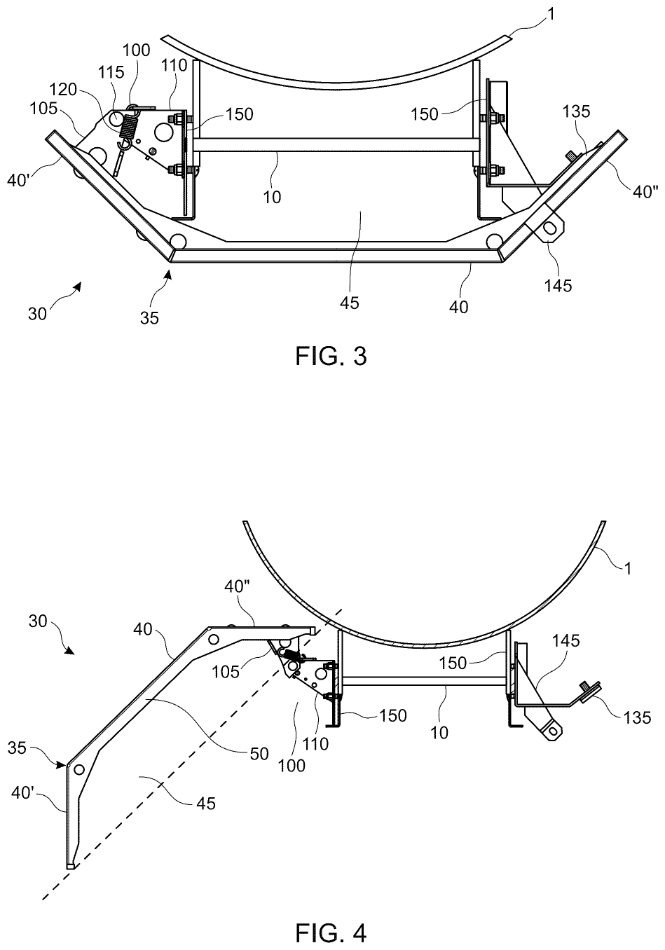

With respect to FIG. 3 and FIG. 4, a more detailed set of views is provided, again illustrating the invention in the second closed position of FIG. 3 and first open position of FIG. 4. Lockout assembly 30 comprises lockout plate 35. Lockout plate 35 comprises central panel section 40, first longitudinal panel section 40′ and opposing second longitudinal panel section 40′. Exemplar dimensions of lockout plate 35 in one embodiment may comprise an approximately 33″ width and approximately 96″ height, each of which may vary based on application requirements.

First longitudinal panel section 40′ and opposing second longitudinal panel section 40″ each angularly and rearwardly depend toward structure 1 from the respective opposing lateral edges of central panel section 40 to define a channel volume 45 for receiving a portion of a length of ladder 10 therethrough.

The various components of lockout assembly 30 may be fabricated from any material suitable for the device's end use environment such as steel or aluminum, as well as a plastic or composite material depending upon a user's structural, environmental, weight, manufacturing or cost constraints.

The rearwardly depending angles of each of first longitudinal panel section 40′ and second longitudinal panel section 40″ are preferably substantially equal and opposite that of the opposing longitudinal panel with each having substantially the same height and width.

First longitudinal panel section 40′ and second longitudinal panel section 40″ extend horizontally outward from central panel section 40 whereby the portion of ladder 10 that passes through channel volume 45 is substantially enclosed within it, and whereby the lateral edges of each of first longitudinal panel section 40′ and second longitudinal panel section 40″ are substantially adjacent structure 1 upon which the ladder 10 is affixed to prevent ladder access by an unauthorized user from either side.

While the illustrated embodiments show generally planar central, first and second longitudinal panel sections 40, 40′ and 40″, it is expressly noted the invention is not limited to such an embodiment and may comprise, for instance, first and second panel sections 40′ and 40″ that depend radially rearward and comprise one or more curved cross-sections.

Lockout plate 35 may further comprise one or more structural reinforcement members 50 such as metal or composite rib members that are horizontally or vertically mounted thereon and in mechanical connection with any or all of central panel section 40, first longitudinal panel section 40′ and second longitudinal panel section 40″.

The horizontal and vertical periphery of lockout plate 35 may comprise a flange element or reinforcement structure for improved structural integrity or rigidity of lockout plate 35.

Lockout assembly 30 further comprises at least one hinge assembly 100 comprising a first hinge bracket 105 and second hinge bracket 110, each of which are rotatably connected with respect to each other by means of pivot pin 115. Hinge assembly 100 may comprise one or more detent means 120 such as a metal helical spring element or elastic element.

Detent means 120 is mechanically coupled to each of first hinge bracket 105 and second hinge bracket 110 such as by the illustrated respective upwardly depending tabs and configured to provide a tensioning or detent force to resist or arrest mechanical movement of lockout plate 35 when in a first open or second closed position and to mechanically urge lockout plate 35 into either or both respective terminal positions.

In an alternative embodiment, a magnetic detent element 120 may be incorporated using, for instance a rare earth magnet element to provide a detent force to lockout plate 35 when lockout plate 35 is in the first open or second closed position.

The one or more hinge assemblies 100 are configured to permit a horizontal rotation of lockout plate 35 about the vertical axis of pivot pin 115. As discussed further in the specification, the one or more hinge assemblies 100 are preferably mounted to ladder 10 using adjustable clamping means 150 to permit a user to selectively adjust an offset distance of lockout plate 35 from the respective ladder side rail upon which the one or more hinge assemblies 100 are mounted.

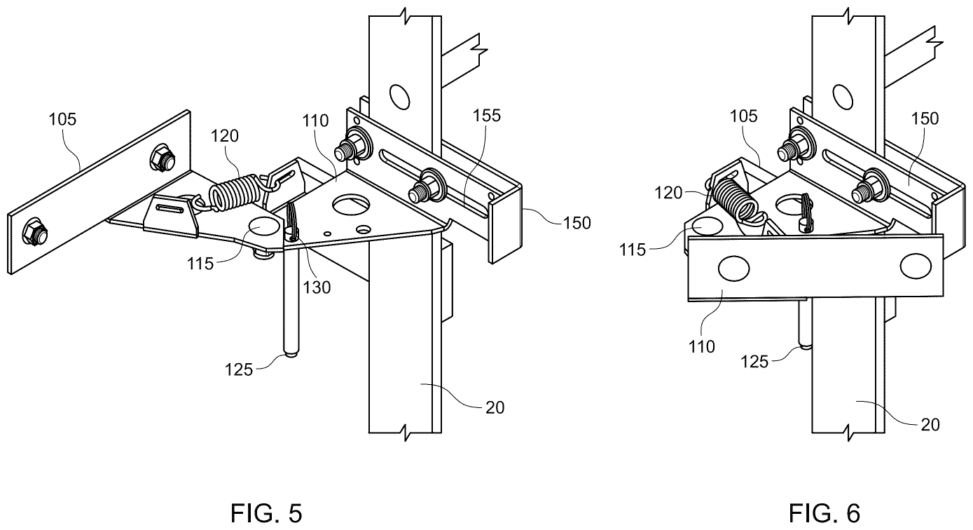

FIG. 5 and FIG. 6 depict hinge assembly 100 in a first open position and second closed position respectively. Hinge assembly 100 is adjustably mounted on ladder side rail 20 or 25 using adjustable clamping means 150 which may comprise the illustrated mounting bracket assembly to permit both vertical and forward-rearward positioning of hinge assembly 100 on a selected side rail.

The one or more or hinge assemblies 100 may comprise a removeable retaining pin 125 for use in cooperation with retaining pin aperture 130. Retaining pin 125 and retaining pin aperture 130 are preferably provided on second hinge bracket 110 and configured to act as a removable securing element to prevent substantial radial movement of first hinge bracket 105 about the central axis of pivot pin 115 for temporarily securing lockout plate 35 in an open or user-defined position.

A stop element 135 is best illustrated in FIG. 3 and FIG. 4 and provided to maintain lockout plate 35 at a stable second closed position and may comprise magnetic means to maintain and urge lockout plate 35 in the second closed position. Stop element 135 is preferably mounted on a ladder side rail and disposed at or near the upper most edge of lockout plate 35 and opposite the side comprising hinge element 100 using adjustable clamping means 150.

Stop element 135 is configured to function as a mechanical stop for the upper interior surface of lockout plate 35 and to magnetically urge lockout plate 35 toward stop element 135 when in the second closed position. This in turn improves stability and reduces potential vibration of lockout plate 35 due to environmental factors such as high wind environments.

Turning back to FIG. 1 and FIG. 2, lockout plate 35 may further comprise a staple aperture 140 for receiving staple shaft element 145 therethrough in similar manner to that of a hasp and staple assembly. Staple aperture 140 in the illustrated embodiment is preferably defined through the thickness of second longitudinal panel section 40″ for the receiving of staple shaft element 145 therethrough when lockout plate 35 is in a closed position.

Staple aperture 140 and staple shaft element 145 are preferably positioned at a height easily accessible to a user standing at ground level for convenient access to a keyed or combination lock used to secure lockout plate 35 in the second closed position.

Staple shaft element 145 is provided as a separate assembly and is preferably mechanically coupled or affixed to second side rail 25 by clamping means 150 such as the illustrated bracket mounting assembly shown in FIG. 5 and FIG. 6.

Adjustable clamping means 150 is used to affix any or all of the one or more hinge assemblies 100, stop element 135 and staple shaft element 145 to ladder side rails 20 or 25.

The one or more hinge assemblies 100, stop element 135 and staple shaft element 145 may each comprise substantially the same clamping components whereby each is preferably vertically and forwardly and rearwardly adjustable. Adjustable clamping means 150 is configured to permit hinge element 100, stop element 135 and/or staple shaft element 145 to be secured to a ladder side rail 20 or 25 at a user-defined position thereon using, for instance, sets of nylon lock nut and bolt pairs.

Hinge assembly 100, stop element 135 and staple shaft element 145 are each preferably disposed on ladder 10 so that they each extend horizontally outwardly from ladder side rails 20 and 25 to minimize their potential interference in the path of a user who is ascending or descending the ladder rungs. Such an orientation desirably permits lockout plate 35 to rotate completely outside the ladder path of a user to enhance safety and ease of ladder access.

Adjustable clamping means 150 may comprise the illustrated bracket components of FIG. 5 and FIG. 6 comprising one or a plurality of slotted or spaced-apart apertures 155 configured to permit a user to adjustably mechanically clamp and affix such assemblies using conventional mechanical fasteners at any user-defined position on the respective opposing ladder rails. This embodiment enables limited adjustment and orientation of adjustable clamping means 150 forwardly or rearwardly with respect to the face of the ladder side rails.

Lockout assembly 30 is preferably mounted at user-selected points on ladder 10 whereby adjustable clamping means 150, hinge assembly 100, stop element 135 and at least a portion of staple shaft element 145 are substantially disposed within channel volume 45 when lockout assembly 30 is in the second closed position. Such a configuration limits unauthorized tampering, theft or damage to the components of lockout assembly 30 when in the second closed and locked position.

Slotted or spaced apart apertures 155 enable the adjustable mounting of the hinge assembly 100, stop assembly 135 and/or staple shaft element 145 to the respective opposing first and second side rails 20 and 25 at a precise user-defined offset distance from the first and second side rails by means of, for instance, sets of nylon nut and bolt pairs or equivalent mechanical fastening means.

This configuration also enables the adjustable clamping of the various ladder-mounted assemblies at any user-defined vertical position on both first side rail 20 and second opposing side rail 25 as well as to permit an adjustable limited lockout assembly 30 offset “Z” distance between the opposing ladder side rails and the structure-facing interior surface of lockout plate 35.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

For example, notwithstanding the fact that the elements of such a claim may be set forth in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a subsequent claim must be understood as being generic to all possible meanings supported by the specification and by the word itself.

The definitions of the words or elements of any claims in any subsequent application claiming priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a subcombination or variation of a subcombination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

Any claims in any subsequent application claiming priority to this application are thus to be understood to include what is specifically illustrated and described above, what is conceptually equivalent, what can be obviously substituted and also what essentially incorporates the essential idea of the invention.

What is claimed:

1. A ladder lockout assembly for limiting access to a ladder comprising:
a lockout plate comprising a central panel section, a first inwardly depending longitudinal panel section and a second inwardly depending longitudinal panel section opposing the first longitudinal panel section,
at least one hinge assembly comprising a first hinge bracket coupled to the lockout plate and a second hinge bracket coupled to the ladder whereby the lockout plate is rotatable between a first open position and a second closed position,
the hinge assembly comprising detent means configured to resist a lockout plate rotation when the lockout plate is in at least one of the first open position or the second closed position, and, mounting means for affixing the ladder lockout assembly to a ladder.

2. The ladder lockout assembly of claim 1 wherein the hinge assembly further comprises a removable retaining pin and a retaining pin aperture configured to receive the retaining pin to selectively limit a rotation of the first hinge bracket or the second hinge bracket when the retaining pin is received within the retaining pin aperture.

3. The ladder lockout assembly of claim 2 further comprising an outwardly projecting staple shaft element coupled to the ladder and comprising a lock hasp aperture, the staple shaft element configured to be received through a staple shaft aperture defined through the lockout plate.

4. The ladder lockout assembly of claim 3 further comprising a stop element coupled to the ladder configured to limit the rotation of the lockout plate at the second closed position.

5. The ladder lockout assembly of claim 4 wherein the stop further comprises a magnet element configured to urge the lockout plate in the closed position.

6. The ladder lockout assembly of claim 5 wherein the mounting means comprises an adjustable clamping means.

7. The ladder lockout ladder lockout assembly of claim 6 wherein at least one of the central panel section, the first longitudinal panel section or the second panel section comprises a planar surface.

8. The ladder lockout assembly of claim 6 wherein at least one of the central panel section, the first longitudinal panel section or the second panel section comprises a radial cross-section.

9. The ladder lockout assembly of claim 6 further comprising at least one lockout plate reinforcement member.

10. The ladder lockout assembly of claim 6 wherein the detent means comprises an elastic element.

11. The ladder lockout assembly of claim 6 wherein the detent means comprises a spring element.

12. The ladder lockout device of claim 11 wherein the spring element comprises a metal helical spring.
